(19) United States
(12) Patent Application Publication
(10) Pub. No.: US 2002/0196793 A1
(43) Pub. Date: Dec. 26, 2002

(54) End-user communication systems access network

(75) Inventors: Augustine S. Samba, Aurora, OH (US); Atila Boros, University Heights, OH (US); Olurinde E. Lafe, Chesterland, OH (US)

Correspondence Address: ARTER & HADDEN, LLP, 1100 HUNTINGTON BUILDING, 925 EUCLID AVENUE, CLEVELAND, OH, 44115-1475, US

(73) Assignee: QuikCAT.com, Inc.

(21) Appl. No.: 09/917,008

(22) Filed: Jul. 27, 2001

Related U.S. Application Data
(60) Provisional application No. 60/253,968, filed on Nov. 29, 2000.

(51) Int. Cl. H04L 12/56

(52) U.S. Cl. 370/401; 370/410

(57) ABSTRACT

A data communication system which facilitates integration of both wireless and wired communication devices with core backbone and service provider networks. The data communication system includes a sub-network which provides enhanced data transport and managed IP services for services providers. Managed IP servers process data at the IP layer, and perform encryption, decryption, compression, and decompression functions, thus enabling the provision of content-based services to end-users.

### RELATED APPLICATIONS

The present application claims the benefit of U.S. Provisional Application No. 60/253,968 filed Nov. 29, 2000.

### FIELD OF INVENTION

The present invention pertains generally to a data communication system, and more particularly to a data communication system which provides wireless and wired communication devices with access to core backbone computer networks, such as the Internet.

### SUMMARY OF THE INVENTION

In accordance with a preferred embodiment of the present invention, there is provided a data communication system comprising: at least one data communication device, each data communication device having a client application; a subnet comprised of: at least one managed IP server for providing data to said at least one data communication device; and at least one gateway router for receiving data into the subnet, transmitting data out of the subnet, and distributing data to said at least one managed IP server, wherein said client application redirects data to said subnet.

In accordance with another aspect of the present invention, there is provided a data communication system comprising: a method of accessing data in a data communication system including: at least one data communication device, each data communication device having a client application; a subnet comprised of: at least one managed IP server for providing data to said at least one data communication device; and at least one gateway router for receiving data into the subnet, transmitting data out of the subnet, and distributing data to said at least one managed IP server, wherein said client application redirects data to said subnet, said method comprising the steps of: intercepting a request for data by the data communication device at the client application; transmitting the request for data from the client application to the subnet; receiving the request for data at one of said at least one gateway routers; directing the request for data to one of said at least one managed IP servers, wherein the managed IP server obtains requested data in response to the request for data; and transmitting the requested data from the managed IP server to the client application.

In accordance with yet another aspect of the present invention, there is provided a method for processing multiple requests for data from multiple host destination sites, the method comprising: intercepting, at a client application, multiple requests for data from multiple host destination sites and respectively assigning an associated channel number to each request, said multiple requests initiated by application service layer processes; combining the multiple requests and the associated channel numbers into a data block; transmitting the data block to a gateway router, wherein said gateway router forwards the data block to a managed IP server; individually initiating the multiple requests for data at the managed IP server via the gateway router; receiving the requested data at the managed IP server and forwarding the requested data to the client application; and forwarding the requested data from the client application to the application service layer processes using the associated channel numbers.

An advantage of the present invention is the provision of a data communication system which provides improved data communication speeds.

Another advantage of the present invention is the provision of a data communication system which decreases network latency.

Still another advantage of the present invention is the provision of a data communication system which provides new and enhanced user services via a communications network.

Yet another advantage of the present invention is the provision of a data communication system which allows for implementation of new and enhanced optimized IP content-based services across a computer network.

Yet another advantage of the present invention is the provision of a data communication system which facilitates integration of end users communication devices into a service provider network.

Still other advantages of the invention will become apparent to those skilled in the art upon reading and understanding of the following detailed description, accompanying drawings and appended claims.

### BRIEF DESCRIPTION OF THE DRAWINGS

The present invention may take physical form in certain parts and arrangements of parts, a preferred embodiment and method of which will be described in detail in this specification and illustrated in the accompanying drawings which form a part hereof, and wherein:

FIG. 1 illustrates a Subnet within the framework of different Internet service provider (ISP) networks, in accordance with a preferred embodiment of the present invention;

FIG. 2 illustrates a Subnet within the framework of a network topology for wholesaling, in accordance with a preferred embodiment of the present invention;

FIG. 3 illustrates a Subnet within the framework of a network topology for an individual Internet service provider (ISP), in accordance with a preferred embodiment of the present invention;

FIG. 4 illustrates a Subnet co-located within strategic data centers of one or more backbone networks, in accordance with a preferred embodiment of the present invention;

FIG. 5 is a block diagram of the distributed architecture of a Subnet, according to a preferred embodiment of the present invention;

FIGS. 6A-B are schematic illustrations of a Subnet gateway's Managed IP Server (MIPS) communication flow over an Extended Internet Protocol (e-IP);

FIG. 7 is a diagram of a division multiplexing scheme, according to a preferred embodiment of the present invention;

FIG. 8A is a schematic illustration of the message flows for the division multiplexing scheme of FIG. 7; and

FIG. 8B is a schematic illustration of the trailing message flows without multiplexing.

### DETAILED DESCRIPTION OF THE PREFERRED EMBODIMENT

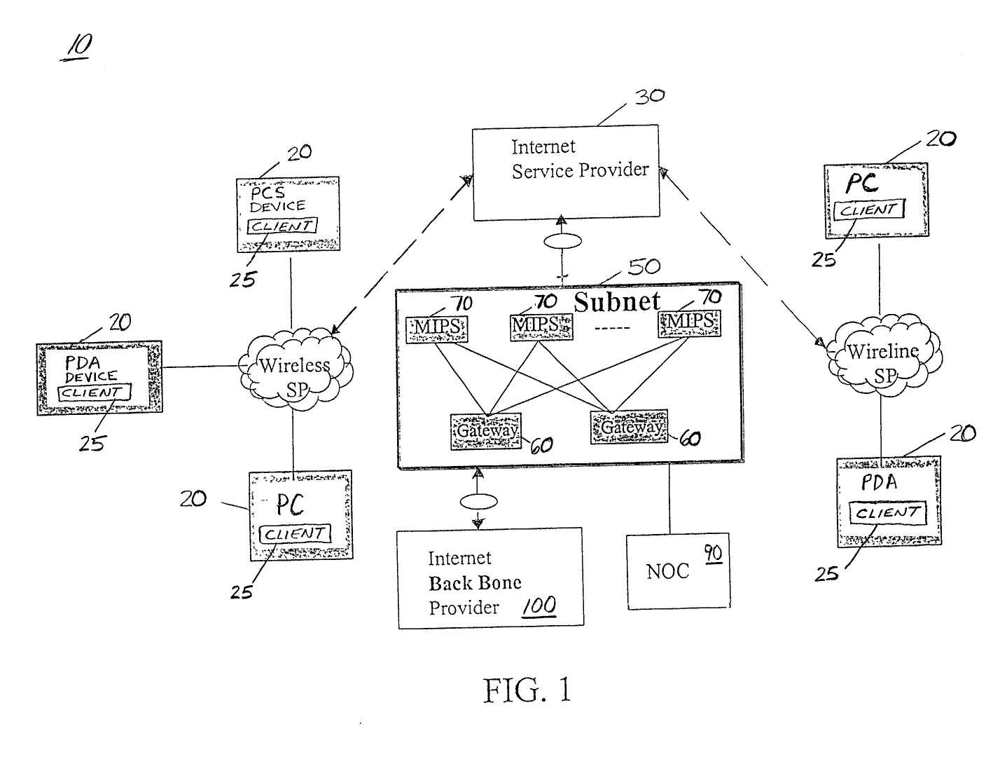

It should be appreciated that the drawings illustrated herein are shown for the purpose of illustrating a preferred embodiment of the invention only and not for purposes of limiting same. Referring now to FIG. 1, there is shown a data communication system 10 generally comprised of a plurality of wireless and wired data communication devices 20 (also referred to herein as the “end-user system”), an Internet service provider (ISP) 30, a Subnet 50, an Internet back bone provider 100 and Network Operations Center (NOC) 90. It should be understood that while a preferred embodiment of the present invention is described with reference to the Internet, other public and private computer networks are also suitably used in connection with the present invention.

Data communication devices 20 may include a variety of different types of devices, including but not limited to: personal digital assistant (PDA), personal communication systems (PCS), and personal computers (PC). It should be understood that each data communication device 20 may include various multi-media data input devices, including but not limited to, a digital camera, a digital video camera, a microphone, a keyboard, and the like. Each of the data communication devices 20 includes a client application 25 embedded in the network access (IP/data link) layer of wireless (mobile) and/or wired (fixed) end-user systems.

The term “subnet” refers to a portion of a computer network that shares a common address component. More specifically, the subnet includes a cluster of devices whose IP addresses have the same prefix. As an example, all devices with IP addresses that start with 100.100.100 would be part of the same subnet. In accordance with a preferred embodiment, Subnet 50 is a local area network (LAN) in the form of a distributed architecture of a plurality of Gateway Routers (“Gateways”) 60 and a plurality of Managed IP Servers (MIPS) 70. Subnet 50 provides data transport and managed IP services for one or more ISPs 30 (e.g., AOL, CoreCom, etc.), and one or more Backbone Service Providers 100 (e.g., UUNET, AT&T, etc.). In accordance with a preferred embodiment, Subnet 50 is preferably designed to integrate seamlessly into an IP-based network. In the case of “network wholesaling,” Subnet 50 provides a link between the wholesaler and customer.

MIPS 70 provide encryption, decryption, compression and decompression of datagrams (wherein a “packet” is comprised of a plurality of datagrams), as will be described in further detail below. It should be understood that MIPS 70 process data at the IP layer, which is analogous to the behavior of Routers. As a result, Transmission Control Protocol (TCP) overhead associated with packet re-assembly and disassembly are eliminated. Furthermore, because MIPS 70 preferably operate on IP datagrams, re-assembly resources are released and network latency is significantly reduced, thereby increasing throughput.

In accordance with a preferred embodiment of the present invention, IP-content based services are provided, including but not limited to: PCS, Medical Applications, and Wireless. Each MIPS 70 communicates exclusively with Gateway Routers 60 over a novel Extended Internet Protocol (e-IP). Gateway Routers 60 preferably take the form of Distribution Routers. The primary function of Gateway Routers 60 is to intelligently distribute datagrams to MIPS 70, and provide a firewall to Subnet 50. Gateway Routers 60 maintain logical associations that correlate the Client Application “requests” and the Destination Host Server “responses” with MIPS 70. These logical associations effectively eliminate the existing need to maintain multiple physical persistent connections (sockets) per client session. Preferably, a mapping table is used to associate various functionalities with a particular MIPS 70 (which may have a specialized function). In this manner, Gateway Routers 60 are able to direct data to an appropriate MIPS 70 that provides the desired function.

Subnet 50 exchanges data with external entities via Gateway Routers 60. Gateway Routers 60 preferably use a standard Interior Gateway Protocol (IGP) to communicate with external entities. An Open Shortest-Path First (OSPF) IGP is preferred as the standard IGP for external communications with routers. OSPF is a link-state protocol, which means that it uses Dijkstra's algorithm, taking into account a variety of link conditions such as the reliability and speed of a link, to calculate shortest (lowest cost) paths, and normally updates other routers with whom they are connected only when their own routing tables change. Also, all OSPF protocol exchanges are authenticated. This means that only trusted routers can participate in the “autonomous system's” routing scheme. Furthermore, OSPF enables flexible configuration of Subnets 50.

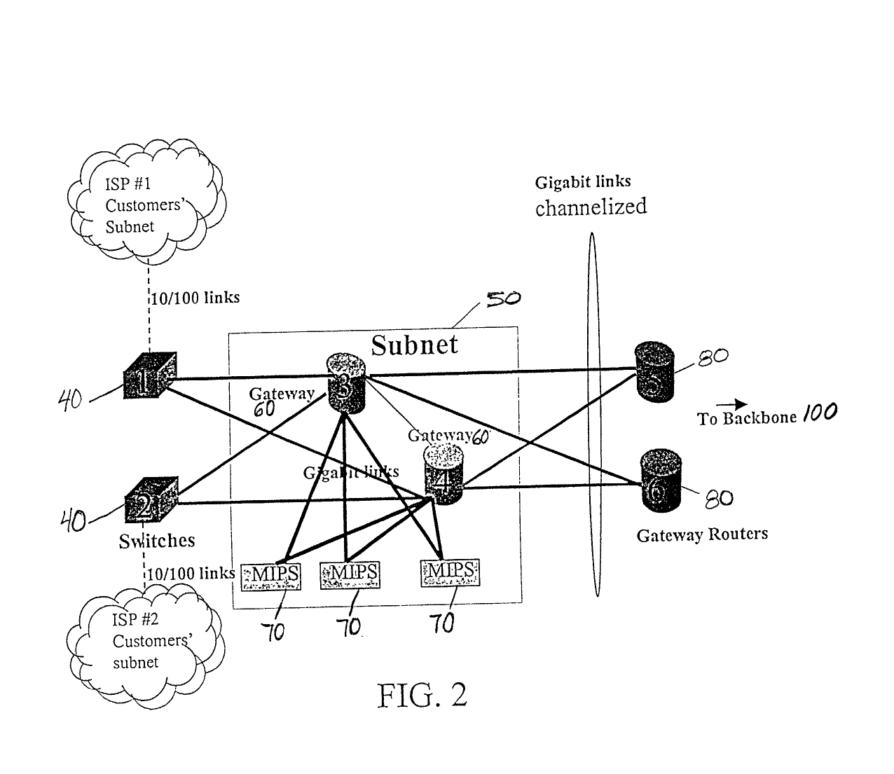

Referring now to FIG. 2, there is shown a diagram illustrating a Subnet 50 within the framework of Backbone Service Provider “wholesaling.” When a Backbone Service Provider sells the services to all ISPs that utilize its backbone, it is referred to as wholesaling. Network wholesaling is the offering of network solutions and services by large service providers for rent or lease to other service providers, independent telephone companies, enterprise customers, and others who are looking to outsource network services. There are two sides to network wholesaling: a wholesale provider, which is usually a large ISP, a competitive local exchange carrier (CLEC), or a carrier; and a wholesale customer, who is the user of the wholesale ports, and which is usually a smaller ISP or enterprise customer. In the wholesaling scenario, Subnet 50 cross-connects Gateway Routers 60 and Terminating Switches 40 that terminate the various ISPs within a Data Center.

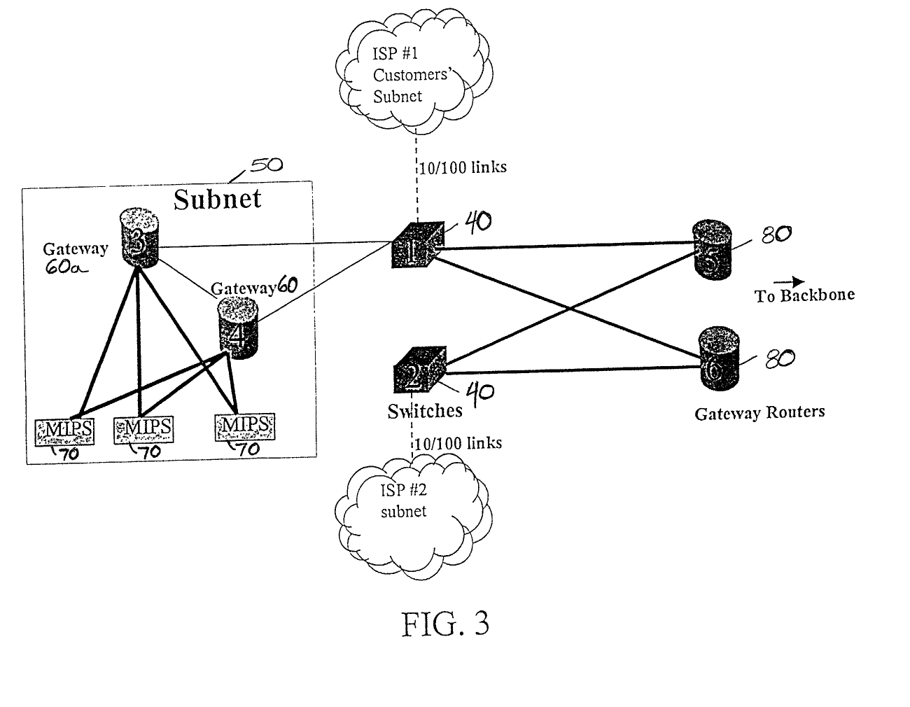

FIG. 3 shows Subnet 50 within the framework of a network topology of an individual ISP. When only a subset of ISPs within a given Data Center subscribes to the services available via Subnet 50, Terminating Switches 40 serve as cross-connect points between the core backbone (e.g., Internet) Gateway Routers and Subnet 50. As illustrated in FIG. 3, ISP #1 subscribes, while ISP #2 does not subscribe.

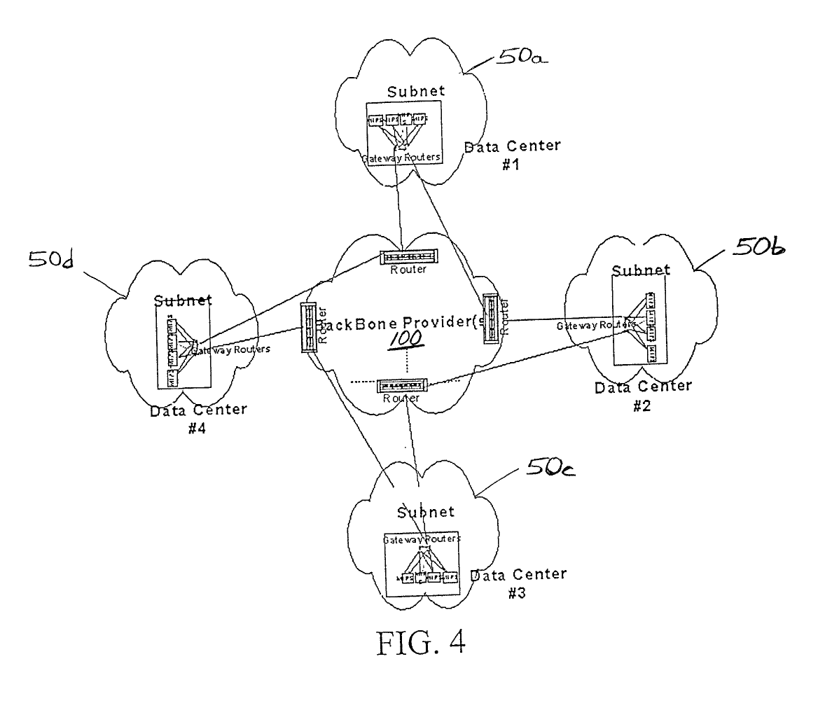

The network architecture of the present invention is generally comprised of two parts, namely Subnet 50 and an array of Level-3 Client Applications 25 embedded in the IP layer of mobile and fixed end-user systems (e.g., data communication devices such as PC, PDA, PCS, etc.). Subnet 50 is co-located within strategic Data Centers of one or more backbone networks, as illustrated in FIG. 4.

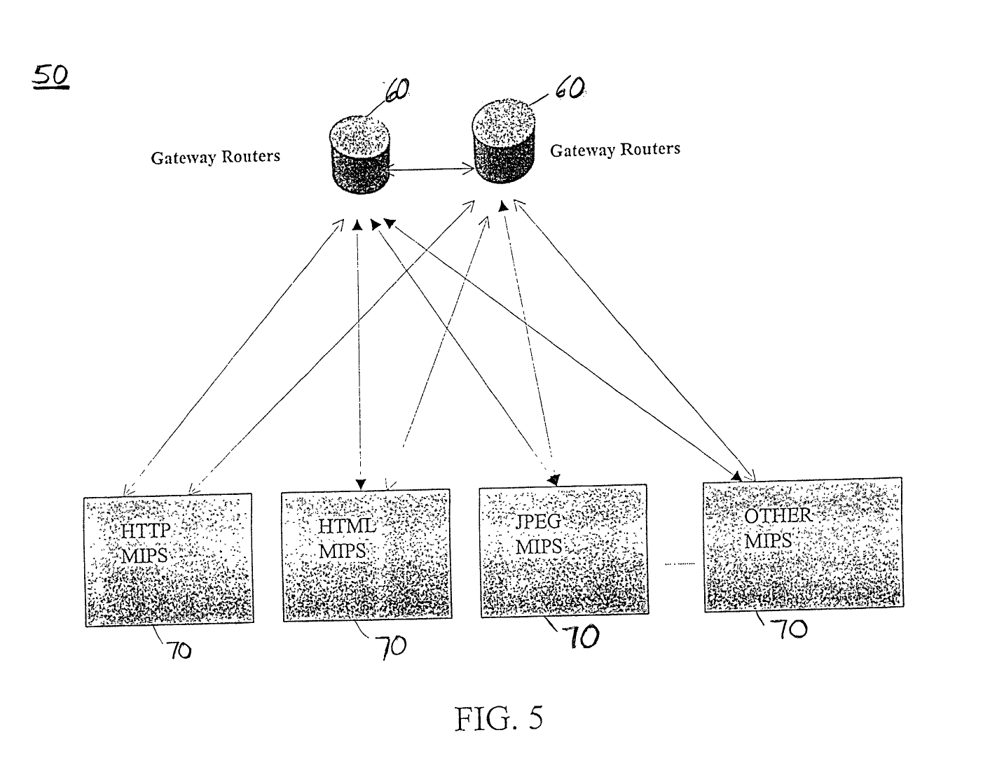

Referring now to FIG. 5, there is shown a functional diagram of the architecture of Subnet 50. The topology of Subnet 50 is a distributed architecture, comprised of a pair of Gateway Routers 60 and a set of MIPS 70. Gateway Routers 60 perform the control functions within each IP Datagram, while MIPS 70 operate exclusively on Data streams within the IP Datagram. Subnet 50 decouples data streams (data portion) from control streams (header portion), which allows for dynamic aggregations of control and data stream support. Decoupling further allows for dynamic load balancing, whereby a Subnet, if a Gateway is overloaded or out of service due to maintenance, upgrade, or failure, can divert the IP datagrams to another Gateway Router 60. If a MIPS is overloaded, the data streams (i.e., content) may be diverted to other MIPS, based on message exchange over the e-IP control link. This provides the ability to essentially hot swap servers. Upon service component failure, there may be a service degradation due to stream diversion, but there will be no denial of service.

Since MIPS 70 operates on datagrams, the overheads associated with packet reassembly and disassembly are eliminated. The flexible architecture of Subnet 50 increases fault tolerance and reliability characteristics, as well as provides a scaleable solution. Furthermore, because access to Subnet 50 is controlled by Gateway Routers 60 via standard interior Gateway Protocols designed for peer-to-peer router communications, Subnet 50 provides for seamless integration in any IP network.

Gateway Router 60 is an IP-level router that has the capability of conforming to specific Internet protocols, such as IP, ICMP, etc. It interfaces with other packet networks and implements standard functions required by the connected networks, such as responding to network flow control, sending and receiving IP datagrams up to the maximum size supported by that network, and receiving and forwarding Internet datagrams.

Management of datagrams: Connections Initiated by External Entities

Remote End User Systems gain access to the network via dedicated connections or dial-up to a Point of Presence (POP) for an Internet Service Provider (ISP). When the client Customer Premises Equipment dials into the ISP, the user is authenticated by the Remote or Network Access Server and assigned a unique IP address. In the case of certain End Users (e.g., Mobile End-User Systems) with static IP addresses and possible International Mobile Identification Numbers (IMSI), the user is simply authenticated. The IP address has two primary components, the Network Number (Net ID) and the Host Number (Host ID). The Net ID identifies the controlling organization (e.g., AOL, CoreCom, Earth Link, etc.) and the Host ID identifies the particular connection within the authority of the organization. Each subscribing ISP provides a set of valid Net IDs to a Subnet network administrator. The Net IDs may be optionally configured/provisioned in Gateway Routers 60 to dynamically screen and control access to the Subnet.

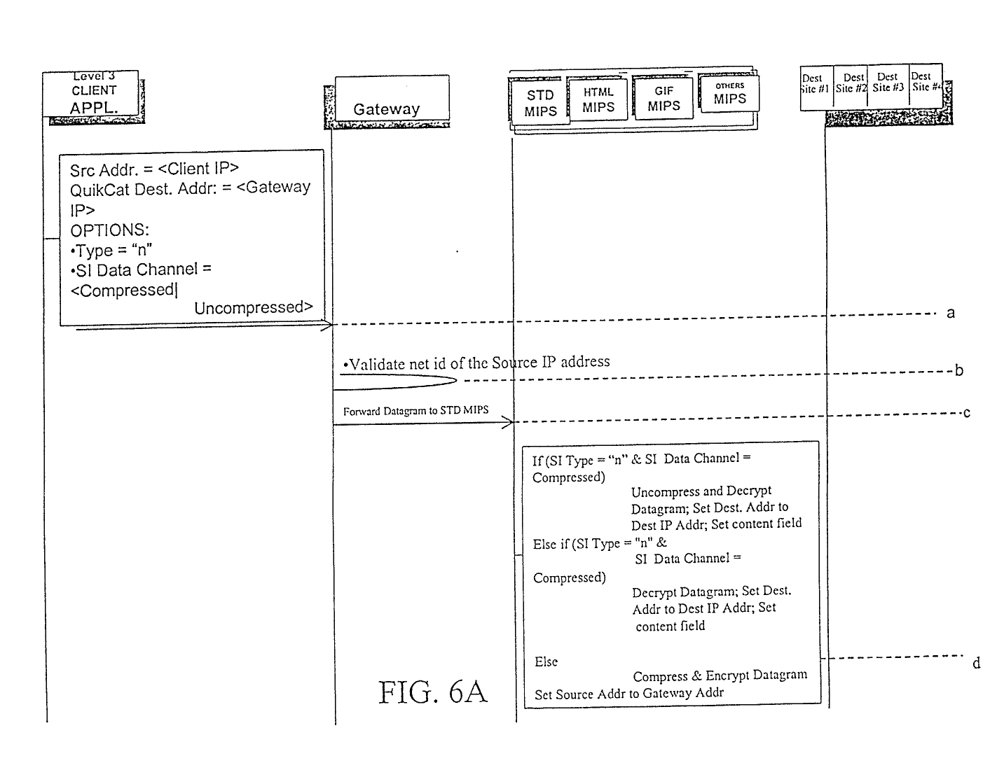

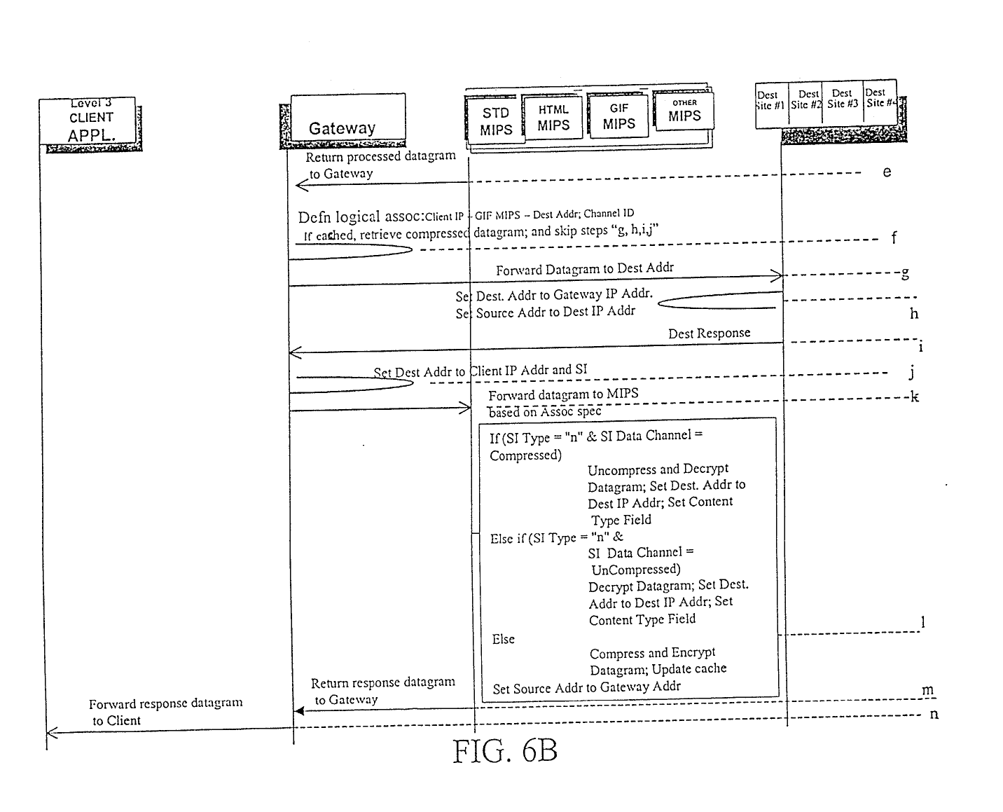

Referring now to FIGS. 6A and 6B, when a connection is initiated by external entities running Level-3 client application 25, the Source Address of the external entity is embedded in the IP header as shown in Table 1A for IPv4, and Tables 1B and 1C for IPv6. The Net ID of the Source Address must be checked (i.e., validated) before performing any further functions on a datagram. If the Destination Address identifies a Subnet Gateway IP address, then the datagram is processed by using the Net ID to assign priorities and/or control routing based on ISP or Backbone Service Provider. Otherwise, the datagram is forwarded to the next hop. After priorities or control routing is assigned, the Options Field is decoded to determine the “Stream Identifier” (SI) and subsequently take appropriate actions based on the value settings.

TABLE 1A

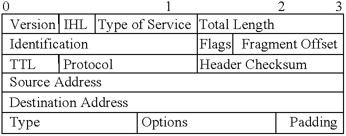

TABLE 1B

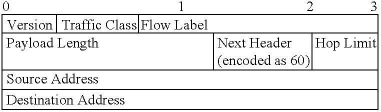

TABLE 1C

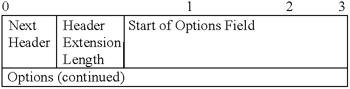

Management of Datagrams: Connections Established by the Gateway to the MIPS

When Gateway Router 60 receives a valid request, it forwards the Level-3 Client initiated IP datagram to the appropriate MIPS 70 (e.g., the HTTP MIPS), based on the supported protocol between the Level-3 Client 25 and Gateway Router 60. The designated MIPS performs decryption, encryption, decompression or compression, as required.

In accordance with a preferred embodiment of the present invention, Level-3 Client 25 may encrypt data being transmitted to Subnet 50. The encrypted data is decrypted by MIPS 70. Similarly, data transmitted from Subnet 50 to Level-3 Client 25 may be encrypted by MIPS 70. In such cases, Level-3 Client 25 decrypts the received data. As will be readily appreciated, encryption of data provides improved security. An encryption algorithm may be selected to provide the desired level of security. Encrypted data may be transferred between Subnet 50 and the destination site, if the destination site has been adapted to encrypt/decrypt data.

Furthermore, in order to save bandwidth and improve data transfer rates, Level-3 Client 25 may compress data being transmitted to Subnet 50. The compressed data may be decompressed by MIPS 70. Similarly, data transmitted from Subnet 50 to Level-3 Client 25 may be compressed by MIPS 70. In such cases, Level-3 Client 25 decompresses the received data. Any suitable compression scheme may be used in connection with the present invention. Furthermore, compressed data may be transferred between Subnet 50 and the destination site, if the destination site has been adapted to compress/decompress data.

When Gateway Router 60 receives the response from MIPS 70, it checks the SI Data Channel Field. If the field has a value for uncompressed data, it defines a logical association, which specifies the virtual connection between Client 25 (Source Address and Channel ID), the Designated MIPS and the Destination Host Server. Otherwise, Gateway Router 60 forwards the datagram to the Level-3 Client 25. When Gateway Router 60 receives the Destination Host Server response, it sets the Destination Address in the IP Header to the Client IP Address, and the SI Data Channel field to the Channel ID, then forwards the IP datagram to the Designated MIPS 70 for compression and encryption.

Management of Datagrams: Connections Established by the Gateway to External Entities (Destination Host Sites)

After defining logical associations, which specify the virtual connections between the Client 25 (Source Address and Channel ID), the Designated MIPS and the Destination Host Server, Gateway Router 60 forwards the uncompressed IP datagram to the Destination Host Server, only if the datagram is not cached within Subnet 50. In this regard, it should be understood that datagrams may be cached at MIPS 70 (preferably compressed), in order to reduce data processing time. Moreover, each MIPS 70 could be used to store different types of data (i.e., separate repositories).

Managed IP Servers (MIPS)

As indicated above, Subnet 50 includes a distributed array of two or more routers, referred to as MIPS 70. The basic functions of MIPS 70 are to provide encryption, decryption, compression and decompression of IP datagrams. MIPS 70 operate at the IP layer. Access to MIPS 70 is controlled by Gateway Routers 60, and therefore MIPS IP addresses are not advertised outside Subnet 50.

When a MIPS 70 receives an IP datagram, it checks the Stream Identifier (SI) in the IP Options field. If the SI Type is set to a pre-determined value and the SI Channel ID is set to Octet value zero, MIPS 70 decrypts the data stream, re-sets the IP Destination Address to the Destination Host Server IP address, and sets the SI Content field to the expected Content Type ID, wherein Gateway Router 60 then uses the SI Channel ID to identify Designated MIPS. MIPS 70 also sets the Source IP address to the Gateway Address, and populates the Destination Host Server address.

If the SI Type is set to a pre-determined value and the SI Channel ID is set to Octet value one, MIPS 70 decrypts and uncompresses the data stream, re-sets the IP Destination Address to the Destination Host Server IP address, and sets the SI Content field to the expected Content Type ID, wherein the Gateway Router 60 uses the SI Channel ID to identify Designated MIPS. MIPS 70 also sets the Source IP address to the Gateway Address, and populates the destination address.

If the SI Type is not set to a pre-determined value or if the SI Channel ID is not set to Octet value of either zero or one, MIPS 70 compresses and encrypts the data stream, sets the Source IP address to the Gateway Address, sets the SI Data Channel field to Compress, only if the data is compressed. Otherwise, SI Data Channel field is set to Uncompressed.

After checking the SI in the IP Options field and performing the appropriate functions, MIPS 70 updates its cache and then returns the processed datagram to Gateway Router 60.

Level-3 Client Applications

Level-3 Client Applications 25 reside in the mobile and fixed End-User Systems 20. The Level-3 Client Application 25 may employ data compression algorithms, including but not limited to: cellular automata transforms (CAT), discrete cosine transform, wavelets, fractal image compression, Huffman coding, arithmetic coding and dictionary techniques (e.g., LZ77 and LZ78), for compression/decompression of IP datagrams. Level-3 Client Application 25 populates the Stream Identifier (SI) in the Options Field of the IP Header. The specifications for the SI are described in Tables 2 - 4. Since Level-3 Client Application 25 provides support to Application Layer Services (e.g., Browsers, FTP and other Applications), it is recommended that the functionality of existing Client Application Layer Service be moved to the network access (IP/data link) layer. Such a move is consistent with the fundamental philosophy of layered architecture (e.g. OSI) and provides for elimination of overheads associated with utilization of API, support for multiple sessions, faster data throughput, and more efficient support for the Application Layer Services.

The Stream Identifier (SI)

The SI is a protocol, which is designed to identify certain characteristics of the data streams that are transported between level-3 Client Application 25, the Gateway Routers 60, and MIPS 70. The SI is embedded in the Options field of the IP header. Table 2 illustrates the four components of the SI.

TABLE 2

| | | | |
|---|---|---|---|
| | | Data | |
| Type | Length (= 4) | Channel | Content Type |

| | | | | | | | |
|---|---|---|---|---|---|---|---|
| 0 | 0 | 0 | 0 | 0 | 0 | 1 | 0 |

Referring to Table 2, the first octet is the Type field, which is used to identify data streams initiated by Level-3 Client Applications 25. The second octet is the Length field, which is used to specify the number of octets in the SI. The third octet is the Data Channel field, which is used to specify whether data is compressed, uncompressed or whether the Channel ID is associated with a compression algorithm. The fourth octet is the Content field, which is used to specify the data content type.

TABLE 3

| Uncompressed Data Stream | | | | | | | | Compressed Data Stream | | | | | | | | Channel ID |
|---|---|---|---|---|---|---|---|---|---|---|---|---|---|---|---|---|
| 0 | 0 | 0 | 0 | 0 | 0 | 0 | 0 | 0 | 0 | 0 | 0 | 0 | 0 | 0 | 1 | n, where n > 1 |

TABLE 4

| Content Type | Content ID | | | | | | | |
|---|---|---|---|---|---|---|---|---|
| HTTP | 0 | 0 | 0 | 0 | 0 | 0 | 0 | 1 |
| HTML | 0 | 0 | 0 | 0 | 0 | 0 | 1 | 0 |
| GIF | 0 | 0 | 0 | 0 | 0 | 1 | 0 | 0 |
| JPEG | 0 | 0 | 0 | 0 | 1 | 0 | 0 | 0 |
| PNG | 0 | 0 | 0 | 1 | 0 | 0 | 0 | 0 |
| BMP | 0 | 0 | 1 | 0 | 0 | 0 | 0 | 0 |
| PPT | 1 | 0 | 0 | 0 | 0 | 0 | 0 | 0 |
| Word | 0 | 0 | 0 | 0 | 0 | 0 | 1 | 1 |
| XLS | 0 | 0 | 0 | 0 | 0 | 1 | 1 | 1 |

Referring now to Table 3, the proposed SI Data Channel Optional values are specified. Table 4 represents proposed IDs for sample content types. The list will be extended to accommodate different compression schemes as they are made available in the future. Table 5 provides a summary of various SI protocol scenarios.

TABLE 5

| | |
|---|---|
| Field | Scenario |

| Name | Set By | Event | Action | Comments |
|---|---|---|---|---|
| Type | Level-3 | Level-3 sends | Flag to identify | |
| | Client | Packets to MIPS, | datagrams | |
| | Application | via Gateway; | | |
| | and | Gateway forwards | | |
| | Gateway | Destination Host | | |
| | | response to MIPS | | |
| Length | Level-3 | Send Packets to | Used by MIPS to | |
| | | MIPS, via Gateway | determine the size of the | |
| | | | Options Field | |
| Length | MIPS | Send datagrams to | Used by Level-3 to | |
| | | Level-3, via | determine the size of the | |
| | | Gateway | Options Field | |
| Data | Level-3 and | Used to distinguish | MIPS will uncompress | |
| Channel | MIPS | between compress | the data if the data | |
| | | and uncompress | channel field is set to | |
| | | data when Level-3 | compress. | |
| | | and MIPS send | | |
| | | messages to each | Level-3 will decompress | |
| | | other via the | the data if the data | |
| | | Gateway | Channel field is set to | |
| | | | compress | |
| Data | MIPS | Used to specify the | Gateway maintains a | The Content |
| Channel | | Level-3 Client | virtual channel, which | ID and the |
| | | channel number | correlates the Level-3 | Channel ID |
| | | when the MIPS | Client, the Channel | are |
| | | initiates a | number and Destination | specified at |
| | | Destination Host | Host address | the same |
| | | request via the | | time |
| | | Gateway | | |
| Content | MIPS | When initiating | Gateway maintains a | |
| | | Destination Host | virtual channel, which | |
| | | request, via | correlates the Level-3 | |
| | | Gateway, to identify | Client, the Channel | |
| | | Designated MIPS | number, Destination Host | |
| | | for processing | address and the | |
| | | Destination Host | Designated MIPS | |
| | | response | | |

Division Multiplexing

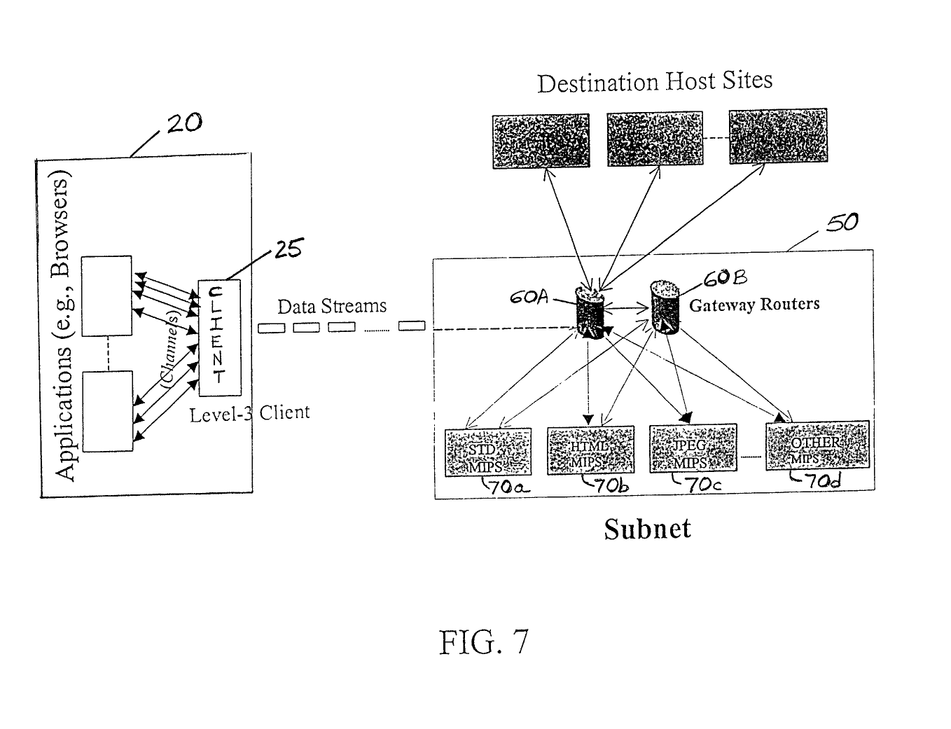

Referring now to FIG. 7, an illustration for the division multiplexing scheme is provided. The division multiplexing scheme includes a Multiple Application Layer Service Requests destined to one or more Host Addresses (e.g., Destination Host Sites), and several content type pages from one or more Host addresses destined to one or more Application Layer Service Process. Several content type pages are usually required for loading a single Destination Host page. For example, a browser may initiate three Requests to three different Destination Host Sites. The division multiplexing scheme is used to multiplex the three Requests by assigning a channel number to each Request. Latency is reduced by concatenating the browser requests, and opening only one network connection for multiple browser requests. In accordance with a preferred embodiment of the present invention, data transferred between Level-3 Client 25 and Subnet 50 may be compressed and encrypted.

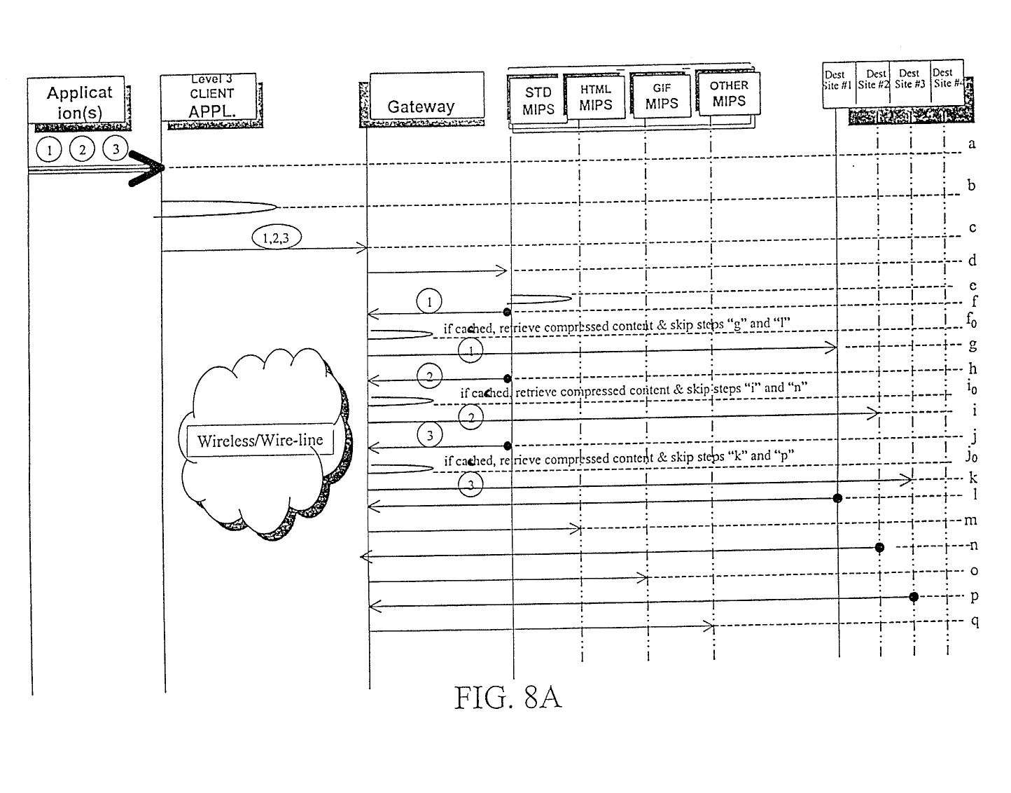

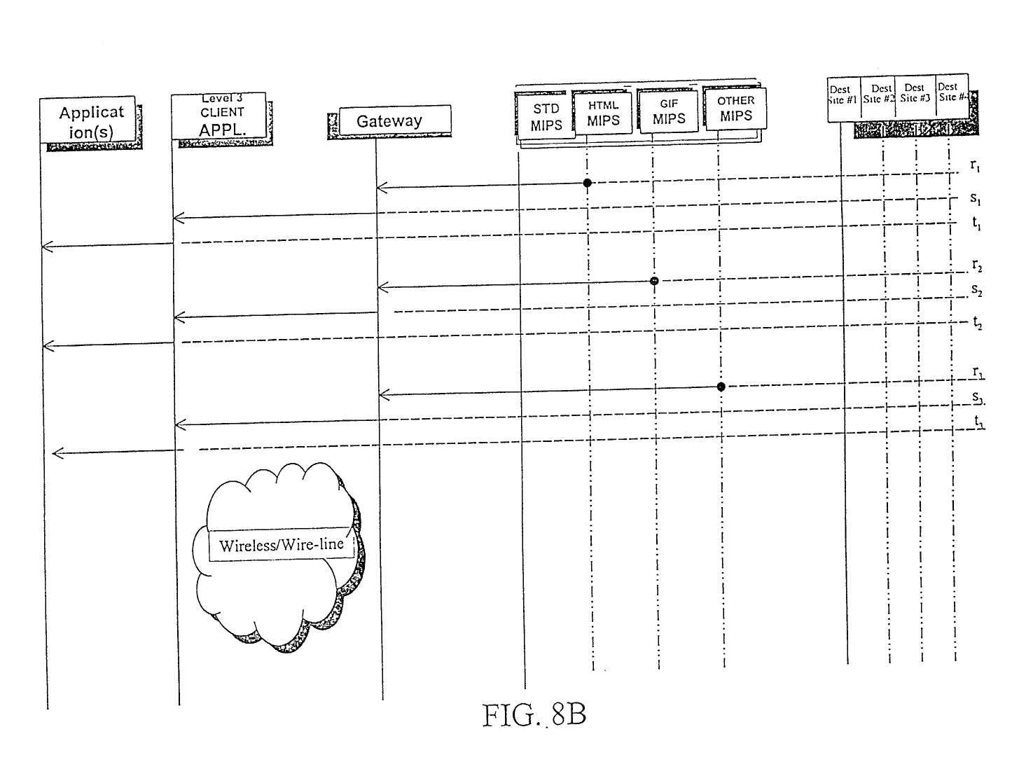

Referring now to FIG. 8A, a schematic illustration of the message flows for the division multiplexing scheme are provided. FIG. 8B provides a schematic illustration of the trailing message flows with no multiplexing. When one or more Application Service Layer Process (e.g., Browsers) initiate multiple Requests to multiple Host Addresses, the Level-3 Client Application assigns unique channel number to each request. The Level-3 Client Application combines the Requests and the associated channel numbers into a block of information. It encrypts the information block and then uses a data compression algorithm (e.g., Cellular Automata Transforms) to compress the information block at a given Quality “Q”, thereby reducing the number of bits to be transmitted. The compressed block is transmitted over a single TCP/IP connection via any wireless (e.g., CDPD, CDMA, or the like) or wire-line network to Gateway Router 60. The information block is conceptually divided into multiple segments. The structure of each block segment is illustrated in Table 6.

TABLE 6

| | | | |
|---|---|---|---|
| Number of bytes | Channel ID | Expected Content ID | Data |

After receiving the compressed block, Gateway Router 60 forwards the information to the appropriate MIPS 70 (e.g., HTTP) for decryption, decompression and de-multiplexing. MIPS 70 preferably employs an Enhanced IP (e-IP) protocol to initiate individual requests, via Gateway Router 60, to the different Destination Hosts. The e-IP specifies the “designated” MIPS for processing the expected content type from the Destination Host. If the content type is already cached within Subnet 50, Gateway Router 60 retrieves the compressed and encrypted content from the designated MIPS, instead of initiating a request to a remote Destination Host. The Subnet Gateway Router 60 maintains a virtual connection, which correlates the Level-3 Client IP Address with the corresponding Destination Host and the designated MIPS. Upon receipt of each Destination Host response, Gateway Router 60 forwards the contents to the respective MIPS 70 based on the individual virtual connections. Each MIPS 70 completes the final processing, and employs the e-IP protocol to initiate a response, via the Subnet Gateway Router 60 to the Level-3 Client Application. The final processing may include Cellular Automata Transform and/or other encryption engines, and caching of compressed content types. Level-3 Client Application 25 decrypts and decompresses each response and employs the Channel number to forward individual responses to the Application Service Layer Processes.

Operation of data communications system 10, in accordance with a preferred embodiment of the present invention, will now be summarized with reference to FIGS. 1, 6A and 6B. An exemplary data exchange will be described with reference to the steps shown in FIGS. 6A and 6B.

STEP a: In the case of an HTTP request (i.e., a datagram including header and data fields) being initiated by a communication device 20, client application 25 associated with the communication device 20 will intercept the HTTP request and change the destination address in the header from the original destination address (e.g., www.NEWS.com) to the destination address of the appropriate Gateway Router 60 of Subnet 50. In this manner, the destination of the HTTP request is redirected to Subnet 50. The original destination address is retained in a data field of the HTTP request.

STEP b: The modified HTTP request is then transmitted to Subnet 50 via wireless SP or wireline SP and Internet service provider 30. The appropriate Gateway Router 60 will validate the “net id” of the source address to determine whether the source communication device is allowed access to Subnet 50.

Step c: If access is allowed, the HTTP request is routed to the appropriate MIPS 70.

Step d: The appropriate MIPS 70 will retrieve the original destination address from the data field and return it to the header field, and will set the source address to the address of the appropriate Gateway Router 60. It should be understood that MIPS 70 will determine whether the received datagram is compressed, uncompressed, encrypted, or decrypted, and operate accordingly.

STEP e: The processed datagram is returned to the Gateway Router 60.

STEP f: If it is determined that the MIPS 70 has cached the requested data, then the compressed datagram (e.g., compressed data from the desired website) is retrieved from the cache and returned to the original source IP address (i.e., client application 25).

STEPS g, h, i, and j are skipped.

STEP g: If the MIPS 70 has not cached the requested data, then the processed datagram is forwarded by the Gateway Router 60 to the destination address.

STEP h: The destination site will respond to the datagram, and set the destination address to the Gateway IP address and set the source address to its site address.

STEP i: The destination response is sent to the identified Gateway Router 60.

STEP j: Gateway Router 60 sets the destination address to the Level-3 Client Application address.

STEP k: Gateway Router 60 forwards the datagram to the appropriate MIPS 70.

STEP l: MIPS 70 determines whether to uncompress and/or decrypt the data, or alternatively, to compress and/or encrypt the data. The source address is set to the address of the Gateway Router 60.

STEP m: The response datagram is returned from MIPS 70 to Gateway Router 60.

STEP n: Gateway Router 60 forwards the response datagram to the Level-3 Client Application to complete the process. The Level-3 Client Application uncompresses/decrypts any compressed/encrypted data and sends it to a browser for display.

It should be appreciated that in one alternative embodiment of the present invention, Gateway Router 60 and MIPS 70 could be used to retrieve actual data from a destination site (without involving client application 25), in such cases where an HTTP request retrieves URLs pointing to actual data, rather than the actual data itself. Moreover, Gateway Router 60 could send an “in progress” message (e.g., 1 bit) to the Level-3 client application indicative of this processing.

As indicated above, the present invention provides a data communication system which allows for implementation of new and enhanced optimized IP content-based services across a computer network. For instance, data communication device 20 may include a data input device for inputting video, image (e.g., a digital camera), and audio data. For example, image data may be transferred from the data communication device (preferably compressed) to subnet 50, for storage at a designated MIPS 70. This image data is then made available for later retrieval. In this manner, MIPS 70 can be used as a repository for video, image, audio and streaming data, and can transfer such data at the IP layer. Other examples include (but are not limited to): mobile and fixed data access and retrieval, electronic banking and financial services, digital data libraries, seamless access to Internet services, and seamless access to Private network services.

The present invention has been described with reference to a preferred embodiment. Obviously, modifications and alterations will occur to others upon a reading and understanding of this specification. It is intended that all such modifications and alterations be included insofar as they come within the scope of the appended claims or the equivalents thereof.

Having thus described the invention, it is now claimed:

1. A data communication system comprising:
at least one data communication device, each data communication device having a client application;
a subnet comprised of:
at least one managed IP server for providing data to said at least one data communication device; and
at least one gateway router for receiving data into the subnet, transmitting data out of the subnet, and distributing data to said at least one managed IP server,
wherein said client application redirects data to said subnet.

2. A data communication system according to claim 1, wherein said at least one managed IP server processes data at an IP layer.

3. A data communication system according to claim 1, wherein said data is a datagram.

4. A data communication system according to claim 3, wherein each of said at least one managed IP servers is specialized for operating on different types of datagrams.

5. A data communication system according to claim 4, wherein said different types of datagrams including at least one of HTTP, HTML, JPEG and GIF.

6. A data communication system according to claim 1, wherein said at least one managed IP server includes a cache for storing data.

7. A data communication system according to claim 1, wherein said data transmitted between said at least one data communication device and said subnet is compressed.

8. A data communication system according to claim 1, wherein said data transmitted between said at least one data communication device and said subnet is encrypted.

9. A data communication system according to claim 1, wherein said at least one managed IP server obtains data from a destination host site, and subsequently transfers the data obtained from the destination host site to said at least one data communication device.

10. A method of accessing data in a data communication system including: at least one data communication device, each data communication device having a client application; a subnet comprised of: at least one managed IP server for providing data to said at least one data communication device; and at least one gateway router for receiving data into the subnet, transmitting data out of the subnet, and distributing data to said at least one managed IP server, wherein said client application redirects data to said subnet, said method comprising the steps of:
intercepting a request for data by the data communication device at the client application;
transmitting the request for data from the client application to the subnet;
receiving the request for data at one of said at least one gateway routers;
directing the request for data to one of said at least one managed IP servers, wherein the managed IP server obtains requested data in response to the request for data; and
transmitting the requested data from the managed IP server to the client application.

11. A method according to claim 10, wherein said managed IP server obtains the requested data from at least one destination host site.

12. A method according to claim 10, wherein said managed IP server obtains the requested data from an associated cache.

13. A method according to claim 10, wherein said at least one managed IP servers processes data at an IP layer.

14. A method according to claim 10, wherein said data is a datagram.

15. A method according to claim 10, wherein said data transmitted between said at least one data communication device and said subnet is compressed.

16. A method according to claim 10, wherein said data transmitted between said at least one data communication device and said subnet is encrypted.

17. A method according to claim 10, wherein said request for data includes a header portion and a data portion, said gateway router decoupling the data portion from the header portion.

18. A method for processing multiple requests for data from multiple host destination sites, the method comprising:
intercepting, at a client application, multiple requests for data from multiple host destination sites and respectively assigning an associated channel number to each request, said multiple requests initiated by application service layer processes;
combining the multiple requests and the associated channel numbers into a data block;
transmitting the data block to a gateway router, wherein said gateway router forwards the data block to a managed IP server;
individually initiating the multiple requests for data at the managed IP server via the gateway router;
receiving the requested data at the managed IP server and forwarding the requested data to the client application; and
forwarding the requested data from the client application to the application service layer processes using the associated channel numbers.

19. A method according to claim 18, wherein said requested data is retrieved by said managed IP server from one or more host destination sites.

20. A method according to claim 18, wherein said requested data is retrieved by said managed IP server from a cache associated with the managed IP server.
